(19) United States
(12) Patent Application Publication
(10) Pub. No.: US 2007/0210291 A1
(43) Pub. Date: Sep. 13, 2007

(54) Portable winching system for spa placement

(75) Inventor: David L. Bailey, Acworth, GA (US)

Correspondence Address: DAVID L. BAILEY, 81 TIMBER CREEK LANE, ACWORTH, GA, 30101, US

(73) Assignee: DAVID L. BAILEY, ACWORTH, GA (US)

(21) Appl. No.: 11/713,578

(22) Filed: Mar. 5, 2007

Related U.S. Application Data
(60) Provisional application No. 60/781,042, filed on Mar. 13, 2006.

(51) Int. Cl. B66D 1/36

(52) U.S. Cl. 254/335

(57) ABSTRACT

This is a portable winching device to facilitate the delivery of spas and hot tubs (or other bulky heavy items) quickly and safely onto high decks or platforms.

The hoisting device consists of a frame with a pivot shaft made preferably of steel or other strong stiff material. Attached to the arm in this case is a conventional winch containing in this case steel aircraft cable of suitable strength to handle the load. Any suitable winch, come-a-long, electric hoist etc. could also be used that is capable of sustaining the weight. The frame also has attached two wheels for mobility. The base frame is temporarily attached to a deck or a structure via four (4) ratchet straps encircling the joist or main supports of the deck base. This provides a very stable lock down of the frame. The pivot shaft is attached to a chain that is attached to the rear of the base frame at two points. When a load is placed on the unit, the chain will support the pivot shaft. The chain will also let the pivot shaft rise to the correct height for ease of use in engaging the winch. When there is no load the chain will collapse lowering the pivot shaft until it is parallel with the base for disassembly.

The spa/hot tub is then placed on the wooden beams of a temporary ramp. A strap capable of handling the weight is placed around the spa/hot tub and tightened. The cable of the portable winch system is attached to the strap on the spa/hot tub via a steel hook. The spa/hot tub can now be pulled onto the deck up the ramp by means of engaging the winch on the pivot shaft of the base unit.

Once the spa/hot tub is in place on top of the deck, the system can then be quickly disassembled and taken to the next job.

Two (2) individuals that are skilled in the delivery and placement of spas/hot tubs can accomplish this portable winching system with ease.

### REFERNCES CITED

| Pat. # | Description | Filing Date |
|---|---|---|
| 6929443: | Lifting and Telescoping Dolley | Aug. 16, 2005 |
| 5505579: | Sliding Carrier | Apr. 09, 1996 |
| 01540630: | Portable Crane | Jun. 2, 1925 |
| 3578179: | Portable jib Crane for back of Truck | Jan. 16, 1969 |
| 4560074: | Scaffold Mounted Hoist | Dec. 24, 1985 |
| 6782972: | Ladder Elevator Device | Aug. 31, 2004 |
| 06640934: | Residential Cargo Lift | Nov. 04, 2003 |
| 04782962: | Back Packable Portable Unit | Feb. 16, 1982 |

### BACKGROUND OF THE INVENTION

The present invention relates to the field of devices used for transporting and hoisting objects, more specifically to the field of winch & hoist devices. Such devices are commonly referred to as hand and electric winches, trailer hoists, portable cranes, and hoists. This invention relates primarily to the spa/hot tub industry and its members' difficulty to safely and efficiently deliver the large, heavy, bulky spas & hot tubs onto high decks without the use of a great deal of labor and or crane & forklift machinery. Many spas sold in this industry are installed onto the back decks of houses. More often than not the deck is 6′ high or higher. This situation poses a problem in putting the spa in place on top of the deck. Using labor and physically picking the spa up or building a ramp and pulling the tub up would typically be the way to address this issue. There is a safety issue with this method along with the expense of labor. As a last resort due to the expense, a crane or forklift would be used. This invention provides an easy and portable method for the professional user to temporarily attach it to decks or platforms quickly, efficiently and safely winch the heavy spa unit to the top for placement. The invention can be quickly assembled, disassembled, and moved to the next job with minimal effort and minimal labor requirements.

### SUMMARY OF THE INVENTION

No state-of-the-art hoisting or winching system offers all the features of the present invention. The present invention features a base in this instance made of steel with a pivot shaft. The pivot shaft has attached a common hand or electric winch with a cable or strap with hook attached. This base is then attached to the joists of a deck or platform via ratcheting tie down straps. A ready-made temporary ramp is attached to the outside joist of the deck or platform. When attached and aligned, this system enables a person to hoist a spa, hot tub, or other load with a flat bottom to the top of the deck. This job would typically be performed with 4 or more persons using a pulling method or the use of expensive crane or forklift machinery. With the present invention there is a large reduction of labor, safety and control is increased, and there is no need for heavy machinery.

This invention provides a very strong pivot shaft in this case made of steel attached to a rectangular base in this case also made of steel. Firmly attached to the top portion of the pivot shaft is a hand or electric winch of appropriate weight limits for the load. Also attached to the pivot shaft below the winch in this case are the two ends of a support chain or other type supports strong enough to handle the weight of the load. The ends of the support chain is attached to the right and left sides of the rear of the base using the attached chain brackets. The entire support base and pivot shaft assembly is then firmly but temporarily attached to the joist of a deck or platform in this case using four ratchet tie down straps of suitable strength.

A temporary ramp is attached to the face joist of the deck or platform. The ramp in this case is made of wood but could be made using material with suitable strength for the job. A spa, hot tub or other load is placed on the ramp bottom down and balanced. A strap, rope, or cable of sufficient strength is placed around the spa, hot tub, or other type of load and secured.

The cable or strap from the winch attached to the pivot shaft is reeled out and attached to the strap around the spa or hot tub using the hook at the free end of the cable. The winch is then engaged. The strapping around the load and cable from the winch tighten. The pivot shaft starts to rise to the extents of the chain supports. The winch is further engaged by the user hoisting the spa up the ramp to the top.

The present invention provides a controllable winching system for the placement of a spa, hot tub or other heavy flat bottom load onto the top of a high deck or platform. This control provides a high level of ease and safety in this winching process that is not available in the spa and hot tub industry at this time. While pulling the item up the ramp, the winching process is a slow gradual lift. The hand or electric winch has a breaking feature that provides the opportunity to stop the hoisting process at any time for adjustment or rest if needed.

The present invention provides in this case the spa and hot tub industry professional a delivery system that can be attached to most decks or platforms quickly and easily. After its use it can be disassembled quickly and easily rolled away using its attached wheels for mobility.

The present invention provides in this case the spa and hot tub industry with a simple, durable, portable, and safe method for the delivery and placement of spas and hot tubs onto high decks and platforms that has never been available until now. It can be easily manufactured and easily used by professionals in the industry.

### BRIEF DESCRIPTION OF THE DRAWINGS

A better understanding of the nature and objects of the present invention will become apparent upon consideration of the following detailed descriptions, taken in connection with the accompanying drawings, wherein:

FIG. 1 is an isometric view of the portable winch system attached to a deck.

FIG. 2 is an isometric view of the portable winch system attached to a deck demonstrating its attached components and securing method.

FIG. 3 is a side view of the portable winch system base structure with detailed views of attached components.

FIG. 4 is an isometric right view of the portable winch system attached to a deck. This view also demonstrates the attachment of a ramp and the placement and hookup of a spa to the portable winch system

FIG. 5 is an aerial view of the portable winch system attached to a deck. This view demonstrates the alignment of all the components of the system. It also demonstrates the method of attachment for securing the portable winch system to the top of a deck or platform.

FIG. 6 is a direct overhead aerial view of the portable winch system attached to a deck. This view demonstrates all of the components of the portable winch system and its method of securely attaching it to a deck.

FIG. 7, FIG. 8, FIG. 9, & FIG. 10 are side views of the portable winch system attached to a deck. These drawings viewed in progression will demonstrate the movement of a spa traveling up the ramp when the portable winch system is engaged.

FIG. 11 is an isometric view of the portable winch system folded and set up for mobility. This drawing demonstrates the portable winch systems' ability to be easily folded and transported to the next job.

### DESCRIPTION OF THE PREFERRED EMBODIMENT

Referring now to the drawings

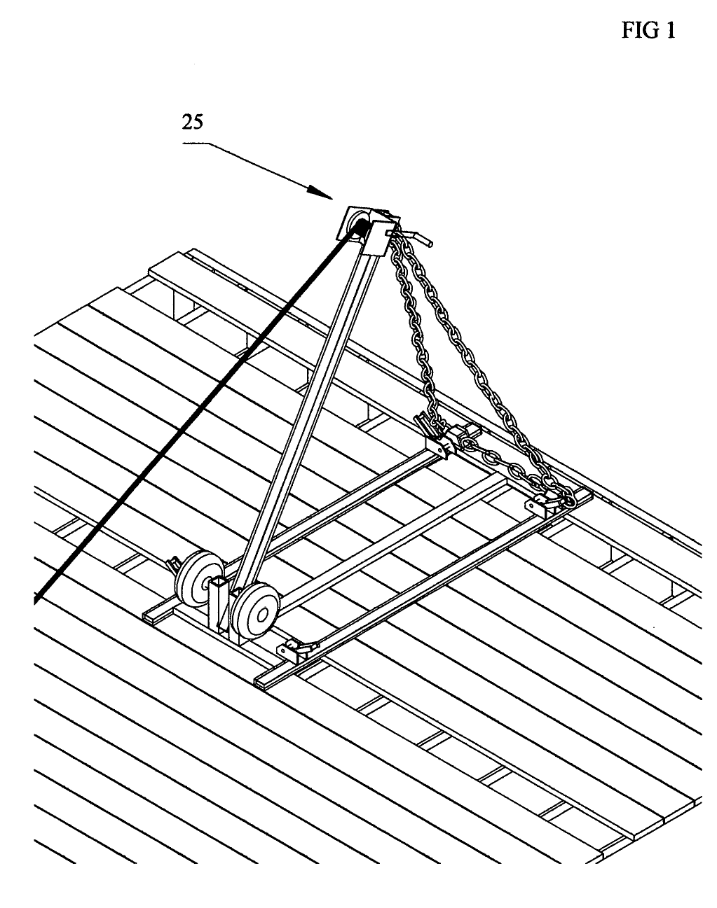

In the drawing FIG. 1 there is shown a portable winch system embodying the present invention #25 mounted to a deck structure.

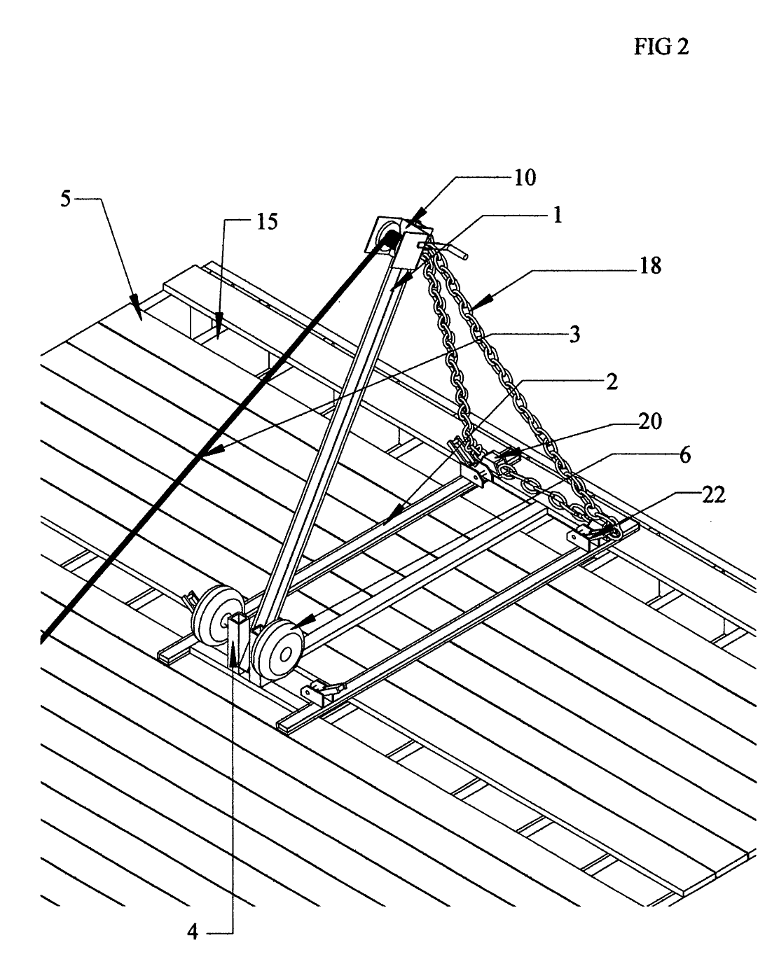

Referring to drawing FIG. 2 there is shown a portable winch system embodying the present invention mounted on a deck #5. The base #2 of the present invention is temporarily secured to the deck #5 with four ratchet tie down straps #22 looped around the deck joist #15 directly under the base #2 on all 4 corners of the base #2. Removing the deck boards under the front and the back of the base #2 accesses the deck joist #15. This provides a very secure but temporary attachment to a deck or platform. Once the base #2 is secured to the deck, the portable winch system can be used to pull a load up a ramp attached the deck. The pivot shaft #1 is in the up position and ready for use. If the pivot shaft is up there is a load attached to the winch #10 and the winch cable #3. The pivot shaft pivots between two uprights #4 attached the base #2. Through the uprights #4 and the pivot shaft #1 is a pin to enable the pivoting action. The pivot shaft support chain #18 is threaded through the chain brackets #20 on the rear of the base. The two free ends of the support chain #18 are attached to the top of the pivot shaft via a bolt & locknut. The support chain #18 is pulled to its extents locking the pivot shaft #1 in the up position as a load (spa) is put onto the winch #10 and the winch cable #3. As the winch #10 is engaged the winch cable #3 is drawn tightly into the winch #10 to pull the load to the top of the deck. The wheels #6 are attached to the base uprights #4. The wheels provide mobility for the unit once it is disengaged from the deck.

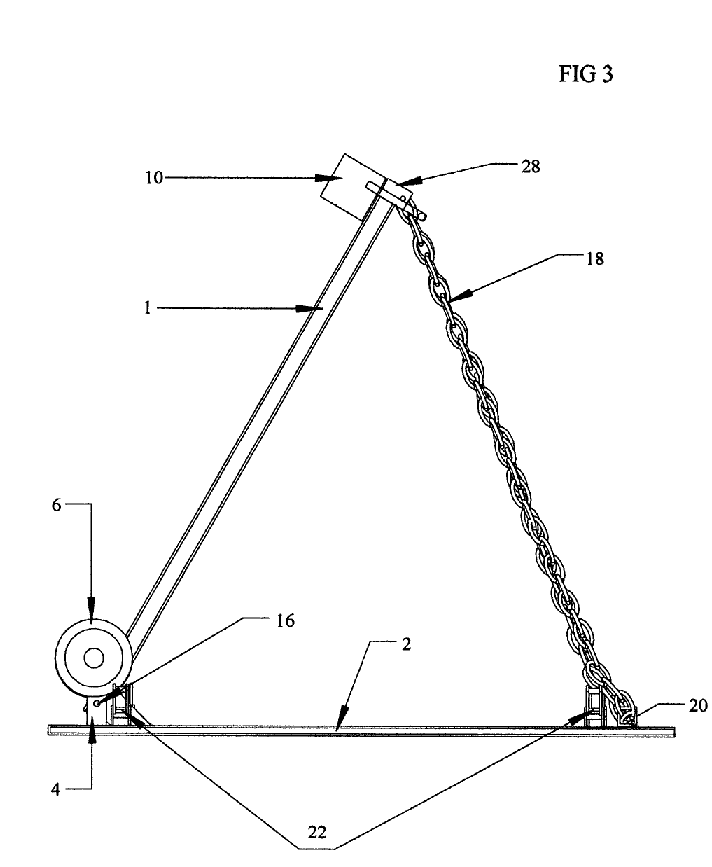

Referring to drawing FIG. 3 there is shown a side view of a portable winch system embodying the present invention. The side view gives a good insight of the various parts of the portable winch system. The base #2 is the foundation for the system. Everything is attached to the base. The base #2 is secured to a deck via the ratchet straps #22. There are four ratchet straps used to secure all four corners of the base #2 during use. Also attached to the base are the base uprights #4. The pivot shaft #1 and the wheels #6 are attached to the uprights #4. The pivot shaft is attached to the uprights using a pivot pin #16 giving it up and down movement. The wheels #6 give the winch system ease of mobility. Attached to the pivot shaft #1 is a common hand winch #10 rated for the intended load. Attached to the rear of the base are the chain brackets #20. The chain brackets #20 are the connection points to attach the support chain #18. The two free ends of the support chain #18 are attached to the pivot shaft bracket with pin #28 at the top of the pivot shaft #1 behind the winch #10. The chain #18 stabilizes the pivot shaft #1 under load and puts the pivot shaft in the up position for ease of access to the winch.

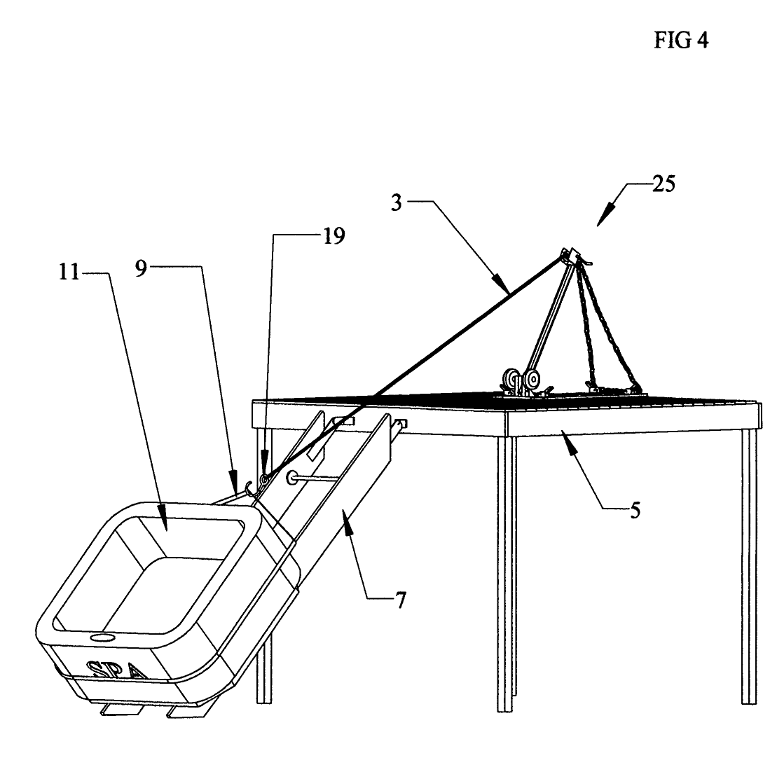

Referring to drawing FIG. 4 there is shown an isometric view of the portable winch system #25 embodying the present invention. This gives a good representation of how the portable winch system will be used. In this view the portable winch system is securely attached to a deck #5. Also attached to the face of the deck is a portable ramp #7. The ramp gives a platform for the spa #11 to slide when the portable winch system #25 is engaged.

Unrolled from the winch system #25 is the winch cable #3. Attached to the free end of the winch cable #3 is a hook #19. Wrapped around the spa is a strap #9 weight rated for the load. The hook #19 from the portable winch system #25 is attached to the strap #9 around the spa #11. The portable winch system #25 is now engaged by the user drawing the winch cable #3 into the winch. This will start pulling the spa #11 (or load) up the ramp #7 until it reaches the top of the deck # 5. Placement of the spa #11 on the top of the deck #5 is the goal of the portable winch system #25.

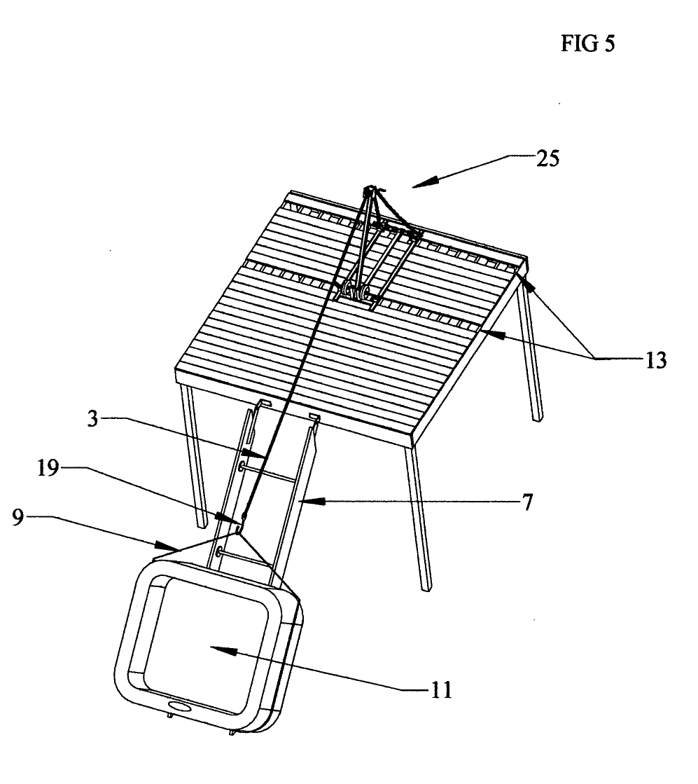

Referring to the drawing FIG. 5 there is shown an isometric ariel view of the portable winch system #25 embodying the present invention. This view demonstrates how the portable winch system is oriented on the deck. The deck boards #13 have been removed for access of the deck joist. The deck joists are the secure attachment points for the portable winch system #25. As seen here, the portable winch system is attached to the deck in the rear middle position. This will give plenty of room to place the spa #11 onto the top of the deck at the completion of the job. The ramp #7 is fastened in the center of the face of the deck in direct line to the portable winch system #25, This will give a straight pull. A straight pull of the load is important in the performance and safety of this system. Once the portable winch system #25 is in straight alignment with the ramp #7, the spa #11 can be placed at the bottom of the ramp #7. A strap #9 with the proper load rating is placed around the spa #11. The winch cable #3 is withdrawn from the winch system #25. The hook #19 attached to the winch cable #3 is hooked to the strap #9 attached to the spa #11. The winch system #25 is then engaged by the user. The cable #3 is drawn into the winch and the spa #9 is pulled to the top of the deck with ease.

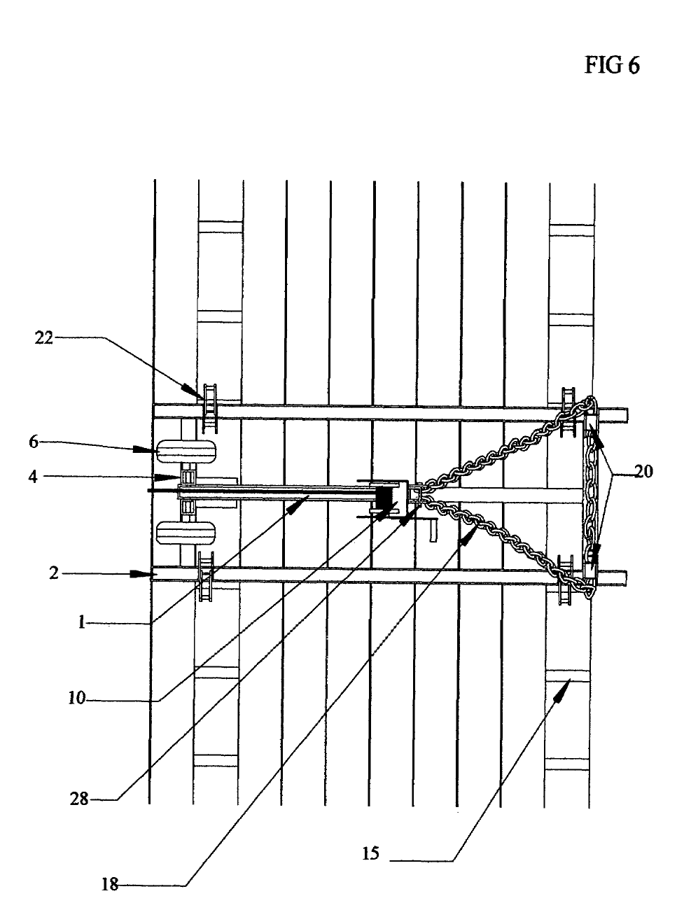

Referring to the drawing FIG. 6. This is a direct overhead view of the portable winch system embodying the present invention. This view gives an excellent picture of all the parts and their placement. In this view the portable winch system is attached to a load in the up position. The pivot shaft #1 is attached to the base uprights #4 and the support chain #18. The support chain #18 is attached to the pivot shaft via the pivot shaft bracket with pin. Also securely attached to the pivot shaft #1 is the hand winch #10. The support chain #18 is threaded through the two chain brackets #20. The support base #2 is temporarily but securely attached to the deck via four ratchet straps #22 at each inside corner of the base #2. The ratchet straps #22 are looped around the deck joists #15 directly under the base #2, which are accessed by the removal of two deck boards.

The two wheels # 6 are attached to the base uprights #4 for mobility of the unit after it has completed its task at hand.

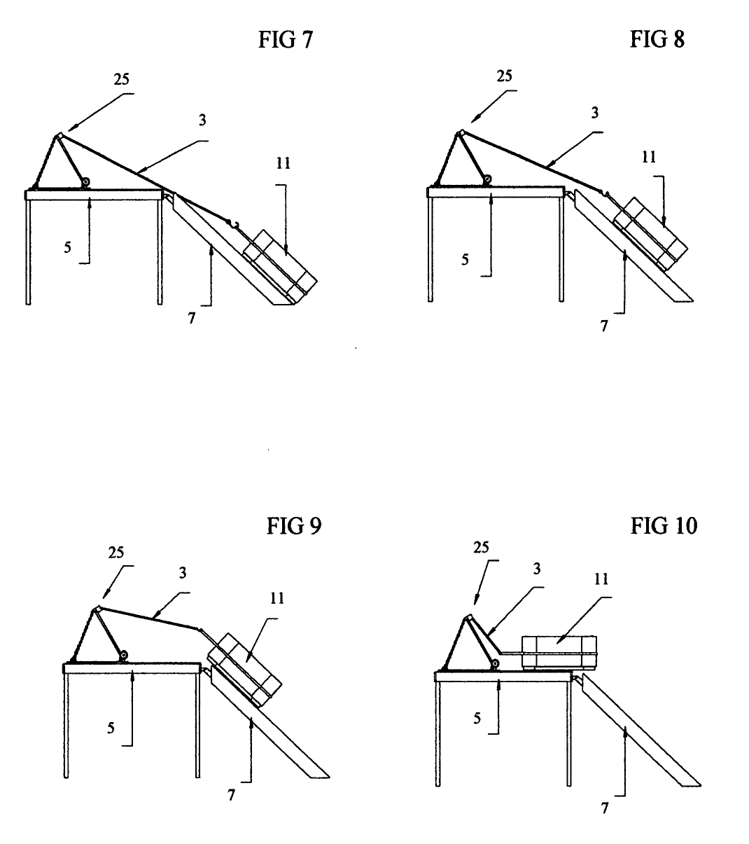

Referring to the drawings FIG. 7, FIG. 8, FIG. 9, & FIG. 10 there is shown a portable winch system embodying the present invention attached to a deck #5. These four drawings in succession show a progression of movement of the spa #11 hooked to the winch cable #3 traveling up the ramp #7 to the top of the deck #5 as the portable winch system is engaged. This also demonstrates a straight-line pull of the spa and a landing area in front of the portable winch system #25 to contain the spa #11 when it reaches the top.

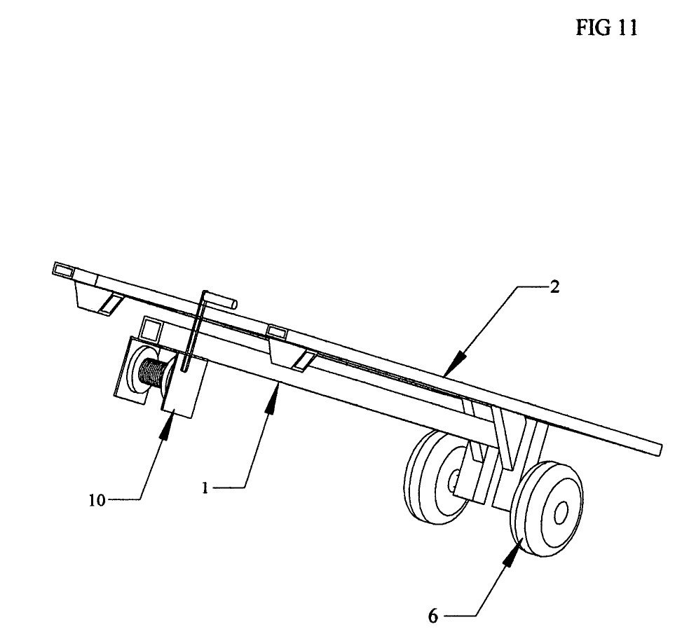

Referring to the drawing FIG. 11 there is shown a portable winch system embodying the present invention. In this view the portable winch system is folded and flipped to place it in a position for mobility. The pivot shaft #1 is placed in the lower position in parallel with the base #2. The wheels #6 are in the down position and are in contact with the ground. The winch #10 remains attached to the pivot shaft. In this position the portable winch system can be rolled to different location or stored with ease due to the fact that it will stand straight up. This also gives a flat surface on the base #2 to place items for easy transport to the job site much like a hand truck.

Since certain changes may be made in the foregoing disclosure without departing from the scope of the invention herein involved, it is intended that all matter contained in the above description and depicted in the accompanying drawings be construed in an illustrative and not in a limiting sense.

I claim the following:

1. A high deck or platform winching system for spa placement designed for pulling spas, hot tubs or other large flat bottom objects up an incline ramp comprising the following:
A substantial framework in this case made of steel for the base. The base in this instance consists of three (3) long square tubular shafts. The three shafts are welded to two (2) perpendicular shafts to create a rectangle. Attached to one end of the base are two (2) steel uprights set apart the same distance as the thickness of the pivot shaft to act as a pivot point for the pivot shaft. Each upright has angled supports welded to the upright and to the middle base shaft. On top of each upright jutting out to the right side and the left side is a round rod to act as an axel for attachment of wheels and tires for portability.
Steel chain brackets are attached on both the right and left sides of the ends opposite the uprights. Threaded through the two chain brackets is a chain of sufficient strength to handle the load. The two free ends of the chain are then attached to the pivot shaft bracket with a pin.
Attached to the uprights on the base is a pivot shaft In this instance made of square tubular steel. The steel shaft pivots on the uprights welded to the base. The attachment is made using a bolt and a nylon-locking nut. The bolt is inserted through the hole in the first upright, through the hole in the steel pivot shaft, then through the 2^{nd} upright. The bolt is then capped with the nylon-locking nut. The steel shaft will now pivot to the limits of the chain.
Two (2) steel plates are welded to both sides of the pivot shaft on the end opposite the pivot uprights. The steel plates have holes on both sides. A bolt is placed through the holes, through the 2 free chain ends, and capped with a locking nylon nut. This is called the pivot chain bracket with pin.
In this instance a hand winch of sufficient weight load capacity containing a length of flexible steel cable of sufficient weight load capacity with a hook is attached to the end of the steel pivot shaft opposite the pivot uprights using bolts, washers, and locknuts.
During use the base is attached to a deck or platform In this case using four (4) ratchet tie down straps of sufficient strength. The straps are encircled around the structure joist of the deck or platform then ratcheted tight. This locks the base down to the deck but keeps the pivot shaft free to move to the limits of the chain. The base is secured to the top of the deck at a minimum of ¼ of the width of the spa away from the front edge of the deck to the leading edge of the base. This will provide needed space on top of the deck to accommodate the spa once it is hoisted to the top. The assembly will now support a predetermined load.
A portable spa/hot tub (or other heavy bulky item of a predetermined size and weight) with a flat sturdy bottom is placed at ground level at the bottom of the beams of a ramp. The spa/hot tub Is then laid to rest on the surface of the ramp and Is now sitting at an angle to the deck in line with the portable winch system. The spa/hot tub should be balanced on both sides of the ramp for even movement up the ramp.
In this case a strap of suitable strength is then placed around the outside perimeter of the spa/hot tub and secured in place. The hook and cable are reeled out from the hand winch of the portable winch system. The hook is then attached to the leading edge of the strap facing the up side of the spa/hot tub.
The portable winch system Is then engaged tightening the cable. As the cable draws tight the pivot shaft will rise to the extent of the chains on the support base. When the chains extend to their limits the winch cable will go taught. The spa will start to slide up the ramp as the hand winch is further engaged drawing in the cable. The spa/hot tub will travel up the ramp In a slow and controlled manner onto the top of the deck. Once spa is on the top of the deck and secured, the portable winch system can then be quickly dissembled.
The portable winch system once dissembled from the deck can be folded and flipped so the wheels are touching the ground. At this point the device can be easily rolled where needed.
